(19) United States
(12) Patent Application Publication
(10) Pub. No.: US 2026/0317614 A1
(43) Pub. Date: Oct. 15, 2026

(54) BETA-TYPE SILICON NITRIDE POWDER, RESIN COMPOSITION, THERMALLY CONDUCTIVE PASTE, AND METHOD FOR MANUFACTURING BETA-TYPE SILICON NITRIDE POWDER

(71) Applicant: MARUWA CO., LTD., Owariasahi-city, Aichi (JP)

(72) Inventors: Osamu Matsumoto, Toki-city, Gifu (JP); Mitsutaka Takahashi, Toki-city, Gifu (JP)

(21) Appl. No.: 19/641,403

(22) Filed: Apr. 7, 2026

(30) Foreign Application Priority Data
Apr. 11, 2025 (JP) 2025-065471

(51) Int. Cl. C09K 5/14; C01B 21/068; C08K 3/34

(52) U.S. Cl. CPC C09K 5/14; C01B 21/0685; C08K 3/34; C01P 2002/72; C01P 2002/74; C01P 2004/03; C01P 2004/54; C01P 2006/32; C08K 2201/001; C08K 2201/016

(57) ABSTRACT

The β-type silicon nitride powder is a β-type silicon nitride powder having a β fraction of 80% or more, characterized in that: Iβ (101)/Iβ (210), which is a ratio between an X-ray diffraction peak intensity Iβ (101) of a (101) plane of β-Si₃N₄ and an X-ray diffraction peak intensity Iβ (210) of a (210) plane of β-Si₃N₄, is 1.1 or more, the X-ray diffraction peak intensities being obtained from an X-ray diffraction pattern of the β-type silicon nitride powder.

### CROSS-REFERENCE TO PRIORITY APPLICATION

This application claims the benefit of priority to Japanese Patent Application No. 2025-65471, entitled “β-TYPE SILICON NITRIDE POWDER, RESIN COMPOSITION, THERMALLY CONDUCTIVE PASTE, AND METHOD FOR MANUFACTURING β-TYPE SILICON NITRIDE POWDER,” filed on Apr. 11, 2025, which is hereby incorporated by reference in its entirety and for all purposes.

### TECHNICAL FIELD

The present disclosure relates to a β-type silicon nitride powder, a resin composition, a thermally conductive paste, and a method for manufacturing a β-type silicon nitride powder.

### BACKGROUND

In recent years, the heat generation density of a power module has increased with increases in densities and outputs of electronic devices and semiconductor devices. A temperature rise of the power module causes malfunction of an element or damage to a circuit board. Heat dissipation performance can be improved by mixing, as a filler, a β-type silicon nitride powder, which is an excellent thermally conductive material, into a resin composition (such as a substrate, a sheet, or a spacer) used in such electronic devices and semiconductor devices, or a paste-like electronic material (thermally conductive paste) such as grease, an adhesive, or a paint.

Here, there are two types of silicon nitride: α-type silicon nitride (α-Si₃N₄) and β-type silicon nitride (β-Si₃N₄) having different crystal phases. The α-type silicon nitride has a property of undergoing an irreversible phase transformation into β-type silicon nitride at a high temperature (around a sintering temperature of 1500 to 1700° C.). Beta (β)-type silicon nitride crystal grains are columnar crystal grains extending in a c-axis direction, and are known to have a higher thermal conductivity than that of α-type silicon nitride crystal grains. A plane orthogonal to the c-axis in the extending direction is defined as ab plane. In general, a hexagonal crystal structure has hexagonal upper and lower faces and six rectangular side faces perpendicular to the opposing upper and lower faces. The hexagonal upper and lower faces are called basal planes, and the six rectangular faces orthogonal to the basal planes are also called prism planes. Therefore, when the silicon nitride powder is used as a filler for heat dissipation material applications, a higher proportion of β-type silicon nitride crystal grains is considered more preferable. In addition, a larger particle size of the β-type silicon nitride crystal grains results in longer thermal conduction paths and is therefore advantageous for heat dissipation of the filler. On the other hand, material characteristics required of the filler include fillability and fluidity (or kneadability). As the fillability of the filler is higher, the powder can be mixed into a material such as a resin at a higher concentration. In addition, as the fluidity of the filler is higher, the filler is easily mixed with the material at a higher concentration.

For example, JP 2015-81205 A discloses a silicon nitride filler to be added to a resin or the like constituting an insulating member for the purpose of improving heat dissipation performance. According to JP 2015-81205 A, when the silicon nitride filler contains 50 vol % or more of agglomerated particles having a particle diameter of 5 μm or more and 200 μm or less, the proportion of particles having a particle diameter of less than 5 μm and particles having a particle diameter of more than 200 μm decreases, so that dispersibility can be enhanced. Further, it is possible to prevent roughening of the surface of a resin composite obtained by mixing the silicon nitride filler with a resin or the like and reduction in mechanical strength, and to enhance thermal conductivity. The silicon nitride filler can be preferably manufactured by a manufacturing method including the following steps. The manufacturing method includes steps of: (a) filling a heat-resistant container with silicon or a mixture of silicon and silicon nitride; (b) producing an agglomerate of silicon nitride by a self-combustion reaction in a non-oxidizing atmosphere containing nitrogen at 1 atm or more; and (c) pulverizing the agglomerate of silicon nitride. Since the self-combustion reaction (nitridation combustion reaction) of silicon proceeds at a high temperature of 1900° C. or higher, the growth of silicon nitride particles sufficiently proceeds in the reaction process, thereby making it possible to obtain an agglomerate having a structure in which β-phase silicon nitride particles having a columnar shape with crystal planes developed as a product are entangled. Alternatively, instead of the method for manufacturing a silicon nitride filler using a self-combustion method, a silicon nitride filler can be obtained by using a direct nitridation method including nitriding granules or a compact of silicon powder in nitrogen at around 1400° C., further developing β-phase columnar particles by heat treatment at a high temperature, and pulverizing agglomerates thereof. The silicon nitride filler thus obtained can be formed into a resin composite containing the silicon nitride filler and a resin composition.

### SUMMARY

In a conventional β-type silicon nitride powder as disclosed in JP 2015-81205 A, the β-type silicon nitride crystal grains are composed of hexagonal columnar grains having a larger particle diameter (length) in the c-axis direction than in an ab in-plane direction, and have a needle shape or elongated columnar shape extending in the major axis (c-axis) direction from the bottom face to the top face, both of these faces defining the polygonal ab planes. For β-type silicon nitride crystal grains produced by a conventional manufacture method, it is known that the particle diameter in the c-axis direction is larger than that in the ab in-plane direction, and that a thermal conductivity in the c-axis direction is about twice higher than that in the ab in-plane direction. When such hexagonal columnar particles long in the c-axis direction are embedded in a resin, the hexagonal columnar particles are oriented such that the ab in-plane direction (minor axis direction) of the hexagonal columnar particles faces a gravity direction (for example, a thickness direction) and the c-axis direction (major axis direction) faces a direction orthogonal thereto (for example, in-plane direction), thereby causing significant anisotropy between the gravity direction and the direction orthogonal thereto. As a result, in a composite product (resin composition) of the silicon nitride filler and the resin, the thermal conductivity in the thickness direction may be about half the thermal conductivity in the in-plane direction. A problem to be solved by the present inventors is to provide a new β-type silicon nitride powder in which a particle diameter of β-type silicon nitride crystal grains in an ab in-plane direction relative to a c-axis direction is made relatively large in order to effectively control anisotropy of thermal conductivity and to enable designing of products having various characteristics.

In order to solve the above problem, an object of some embodiments of the present disclosure is to provide a β-type silicon nitride powder having a particle shape in which a particle diameter in an ab in-plane direction is larger than that in a c-axis direction, a resin composition containing the β-type silicon nitride powder, a thermally conductive paste containing the β-type silicon nitride powder, and a method for manufacturing the β-type silicon nitride powder.

### (Configuration 1)

A β-type silicon nitride powder according to an aspect of the present disclosure is a β-type silicon nitride powder having a β fraction of 80% or more, characterized in that:
Iβ (101)/Iβ (210), which is a ratio between an X-ray diffraction peak intensity Iβ (101) of a (101) plane of β-Si₃N₄ and an X-ray diffraction peak intensity Iβ (210) of a (210) plane of β-Si₃N₄, is 1.1 or more, the X-ray diffraction peak intensities being obtained from an X-ray diffraction pattern of the β-type silicon nitride powder.

### (Configuration 2)

A β-type silicon nitride powder according to a further aspect of the present disclosure is more suitably the β-type silicon nitride powder according to Configuration 1, characterized in that: an average aspect ratio W/L is 2.5 or more, where L is a length of primary particles in a c-axis direction, and W is a length of the primary particles in an ab in-plane direction.

### (Configuration 3)

A β-type silicon nitride powder according to an aspect of the present disclosure is a β-type silicon nitride powder having a β fraction of 80% or more, characterized in that:
an average aspect ratio W/L is 2.5 or more, where L is a length of primary particles in a c-axis direction, and W is a length of the primary particles in an ab in-plane direction.

### (Configuration 4)

A β-type silicon nitride powder according to a further aspect of the present disclosure is more suitably the β-type silicon nitride powder according to any of Configurations 1 to 3, characterized in that a thermal conductivity is 0.1 W/mK or more.

### (Configuration 5)

A β-type silicon nitride powder according to a further aspect of the present disclosure is more suitably the β-type silicon nitride powder according to any of Configurations 1 to 4, characterized in that the β-type silicon nitride powder contains a Sr element.

### (Configuration 6)

A resin composition according to an aspect of the present disclosure is characterized by containing the β-type silicon nitride powder according to any of Configurations 1 to 5.

### (Configuration 7)

A resin composition according to a further aspect of the present disclosure is more suitably the resin composition according to Configuration 6, characterized in that the resin composition is a thermoplastic resin or a thermosetting resin.

### (Configuration 8)

A thermally conductive paste according to an aspect of the present disclosure is characterized by containing the β-type silicon nitride powder according to any of Configurations 1 to 5.

### (Configuration 9)

A manufacturing method according to an aspect of the present disclosure is a method for manufacturing a β-type silicon nitride powder having a β fraction of 80% or more,
the method being characterized by including:
a step of producing a mixed powder containing: a raw material containing a predetermined amount of a SiO₂ powder and a predetermined amount of a Sr compound powder; and a predetermined amount of a carbon powder; and
a step of nitriding the mixed powder by a reductive nitridation reaction in a nitrogen atmosphere.

### (Configuration 10)

A manufacturing method according to a further aspect of the present disclosure is more suitably the method according to Configuration 9, characterized in that the Sr compound powder is a halogen compound powder.

### (Configuration 11)

A manufacturing method according to a further aspect of the present disclosure is more suitably the method according to Configuration 9 or 10, characterized in that an amount of the Sr compound to be added is 5 to 10 mol % relative to 100 mol % of the SiO₂ powder.

### (Configuration 12)

A manufacturing method according to a further aspect of the present disclosure is more suitably the method according to any of Configurations 9 to 11, characterized in that a molar ratio (C/SiO₂) between the carbon powder and the SiO₂ powder is 2 to 3.

### (Configuration 13)

A manufacturing method according to a further aspect of the present disclosure is more suitably the method according to any of Configurations 9 to 12, characterized in that the reductive nitridation reaction is performed in a temperature environment of 1450 to 1600° C.

### (Configuration 14)

A manufacturing method according to a further aspect of the present disclosure is more suitably the method according to any of Configurations 9 to 13, characterized in that the reductive nitridation reaction is performed in a nitrogen atmosphere at 2 atm or more.

Since the β-type silicon nitride powder of some embodiments of the present disclosure has Iβ (101)/Iβ (210) of 1.1 or more and/or an average aspect ratio W/L of 2.5 or more, the β-type silicon nitride powder has a particle shape having a particle diameter in the ab in-plane direction larger than that in the c-axis direction, and exhibits a particle shape suitable for use as a filler for heat dissipation applications.

### BRIEF DESCRIPTION OF THE DRAWINGS

FIG. 1 shows X-ray diffraction patterns of silicon nitride powders of Examples 1 to 4 and Comparative Examples 1 to 3;

FIG. 2 is an SEM photograph of a silicon nitride powder of Example 1;

FIG. 3 is an SEM photograph of a silicon nitride powder of Example 2;

FIG. 4 is an SEM photograph of a silicon nitride powder of Example 3;

FIG. 5 is an SEM photograph of a silicon nitride powder of Example 4;

FIG. 6 is an SEM photograph of a silicon nitride powder of Comparative Example 1;

FIG. 7 is an SEM photograph of a silicon nitride powder of Comparative Example 2;

FIG. 8 is an SEM photograph of a silicon nitride powder of Comparative Example 3; and

FIG. 9 is a plan projection view (SEM photograph) of β-Si₃N₄ crystal particles, illustrating an example of selecting primary particles in which a length W in a width direction (ab in-plane direction) of a basal plane and a length L of a prism plane (c-axis direction) connecting the basal planes can be discriminated and measuring the lengths W and L.

### DETAILED DESCRIPTION OF PREFERRED EMBODIMENTS

A β-type silicon nitride powder according to an embodiment is an assembly of silicon nitride particles, and has a β fraction of 80% or more. That is, the silicon nitride powder contains 80% or more, preferably 98% or more, of β-type silicon nitride (β-Si₃N₄) particles among α-type silicon nitride (α-Si₃N₄) particles and the β-type silicon nitride particles. Since the silicon nitride powder contains 80% or more of the β-type silicon nitride particles, the silicon nitride powder can have a significantly higher thermal conductivity than that of an α-type silicon nitride powder in which the α-type silicon nitride particles are dominant. In addition, the β-type silicon nitride powder can used, without limitation, as a heat dissipation (or heat conduction) filler that improves heat dissipation by being dispersed in a resin composition (such as a substrate, a sheet, or a spacer) or a paste-like electronic material such as grease, an adhesive, or a paint. The β-type silicon nitride powder may be used as a single main filler, or may be used as a sub filler to be added to the main filler.

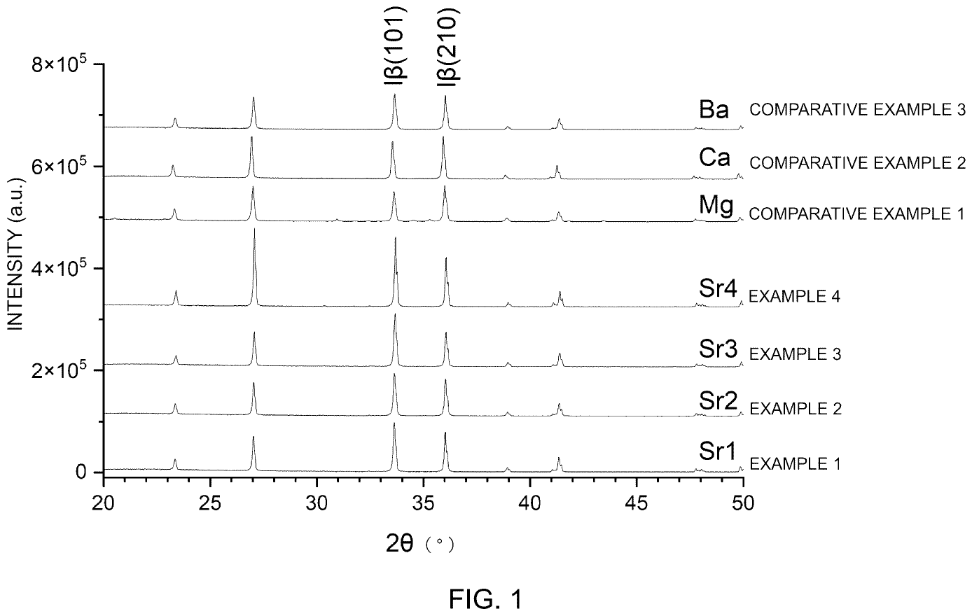

The β-type silicon nitride powder of some embodiments of the present disclosure is characterized in that: Iβ (101)/Iβ (210), which is a ratio between an X-ray diffraction peak intensity Iβ (101) of a (101) plane of β-Si₃N₄ and an X-ray diffraction peak intensity Iβ (210) of a (210) plane of β-Si₃N₄, is 1.1 or more, the X-ray diffraction peak intensities being obtained from an X-ray diffraction pattern of the β-type silicon nitride powder. FIG. 1 illustrates the X-ray diffraction pattern of the β-type silicon nitride powder of the present embodiment. Powder X-ray diffraction measurement was performed on a measurement surface formed by smoothing the surface of the powder through compression with a slide glass.

In general, according to “01-078-2963” of “2022 International Centre for Diffraction Data”, the 2θ, Miller indices (hkl) and diffraction peak intensities I of β-Si₃N₄ powders in an X-ray diffraction method using Cu-Kα rays are respectively given by Table 1 below. The β-Si₃N₄ powders have a random orientation.

TABLE 1

| 2θ | hkl | I |
|---|---|---|
| 23.39 | 110 | 333 |
| 27.07 | 200 | 985 |
| 33.70 | 101 | 999 |
| 36.08 | 210 | 970 |
| 41.43 | 201 | 312 |

According to Table 1, the intensity ratio Iβ (101)/Iβ (210) between the X-ray diffraction peak intensity Iβ (101) of the (101) plane of β-Si₃N₄ and the X-ray diffraction peak intensity Iβ (210) of the (210) plane thereof is 1.03 (=999/970). That is, the intensity ratio Iβ (101)/Iβ (210) is about 1 in a random orientation state.

In the present embodiment, based on a comparison between the X-ray diffraction peak intensity Iβ (101) of the (101) plane of β-Si₃N₄ and the X-ray diffraction peak intensity Iβ (210) of the (210) plane thereof, a difference in relative size between the particle diameter in the c-axis direction of the β-type silicon nitride crystal grains and the particle diameter in the ab in-plane direction (orthogonal to the c-axis) was statistically evaluated. In the measurement surface formed by smoothing the surface of the crystal grain through compression, the larger Iβ (101) is, the higher the proportion of particles whose ab in-plane direction is parallel to the measurement surface is, and on the other hand, the larger Iβ (210) is, the higher the proportion of particles whose c-axis direction is parallel to the measurement surface is. In general, the particles tend to be oriented such that the direction with a larger particle diameter (major axis direction) is parallel to the measurement surface at the time of smoothing through compression. When the Iβ (101)/Iβ (210) is about 1, the ab in-plane direction and c-axis direction of the particles are randomly oriented, and, theoretically, there is no difference in particle diameter between the ab in-plane direction and the c-axis direction. Then, when the intensity ratio Iβ (101)/Iβ (210) is significantly larger than 1, particles in which the ab in-plane direction of the particles is parallel to the measurement surface are dominant, and thus it can be concluded that the particle diameter in the ab in-plane direction of the particle shape of the β-type silicon nitride crystal grains is larger than the particle diameter in the c-axis direction. In the β-type silicon nitride powder of the present embodiment, the Iβ (101)/Iβ (210) is 1.1 to 1.5, which quantitatively indicates that the particle diameter in the ab in-plane direction of the particle shape is significantly larger than the particle diameter in the c-axis direction.

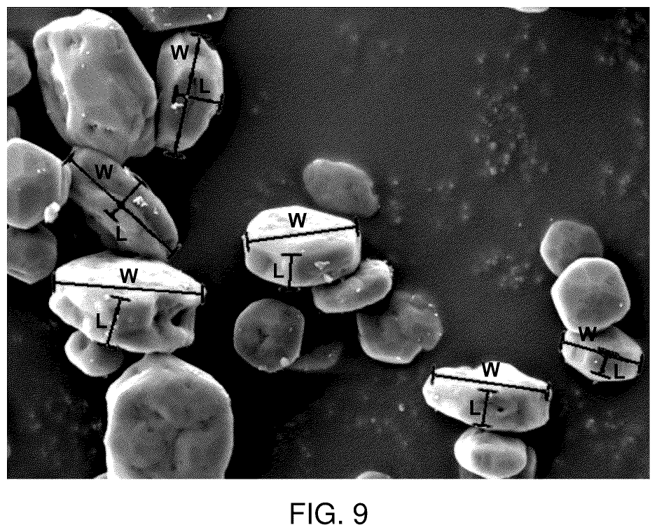

The β-type silicon nitride powder of the present embodiment is characterized in that an average aspect ratio W/L is 2.5 or more, where L is a length of primary particles in a c-axis direction, and W is a length of the primary particles in an ab in-plane direction. The aspect ratio is an index indicating the shape of the primary particles. The average aspect ratio of the primary particles is obtained by analyzing a plan projection image by SEM. The average aspect ratio is an average value of aspect ratios of 50 or more particles. When the average aspect ratio is larger than 1, the length W in the ab in-plane direction of the primary particles is larger than the length L in the c-axis direction, in many particles. In the β-type silicon nitride powder of the present embodiment, preferably, an average length W of 50 or more particles is 1.8 to 3.0 μm, an average length L of 50 or more particles is 0.6 to 1.2 μm, and the average aspect ratio W/L is in the range of 2.5 to 4.0. More preferably, the average aspect ratio W/L is 2.6 to 3.8. This quantitatively indicates that the particle diameter in the ab in-plane direction of the particle shape is significantly larger than the particle diameter in the c-axis direction. In an SEM image, lengths of particles in which both basal planes and prism planes can be confirmed were measured. A length W in a width direction of a hexagonal basal plane and a length L of a prism plane connecting the basal planes, in a plan projection view of β-Si₃N₄ crystal particles, were measured. FIG. 9 illustrates an example of a method of measuring the lengths W and L in each primary particle.

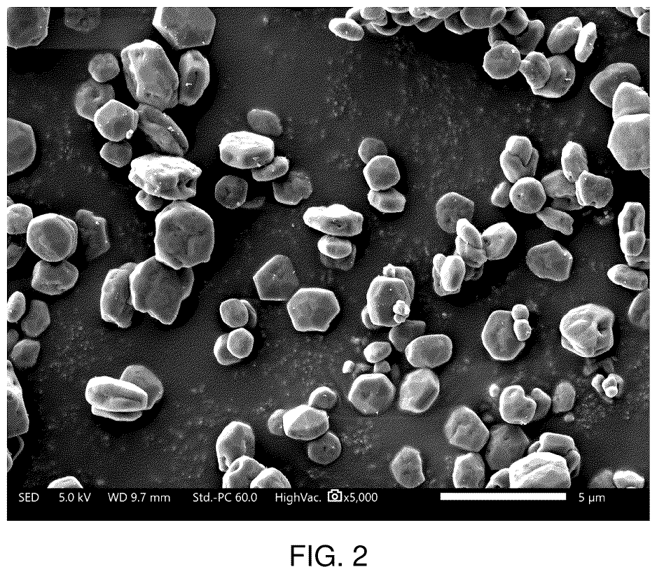

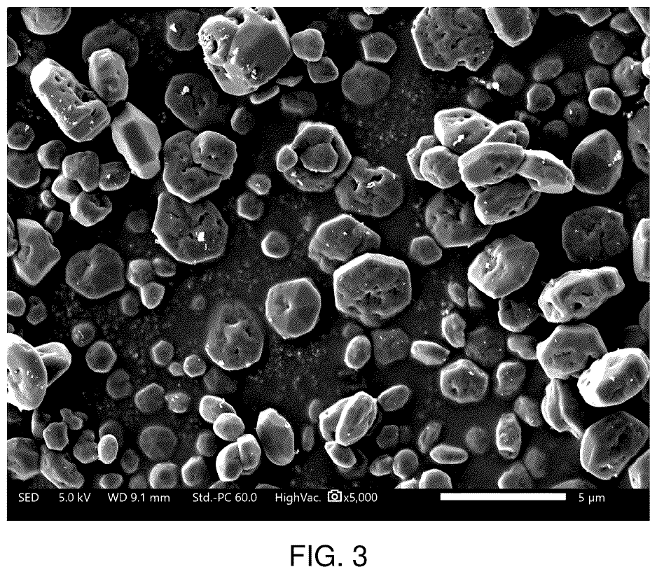

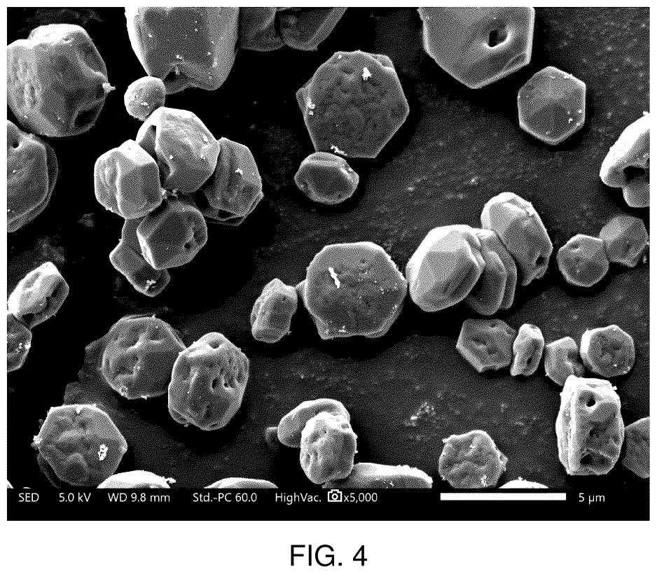

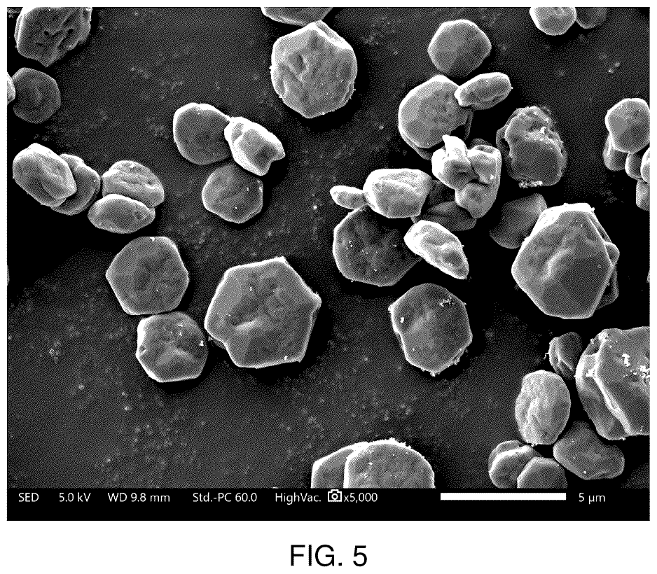

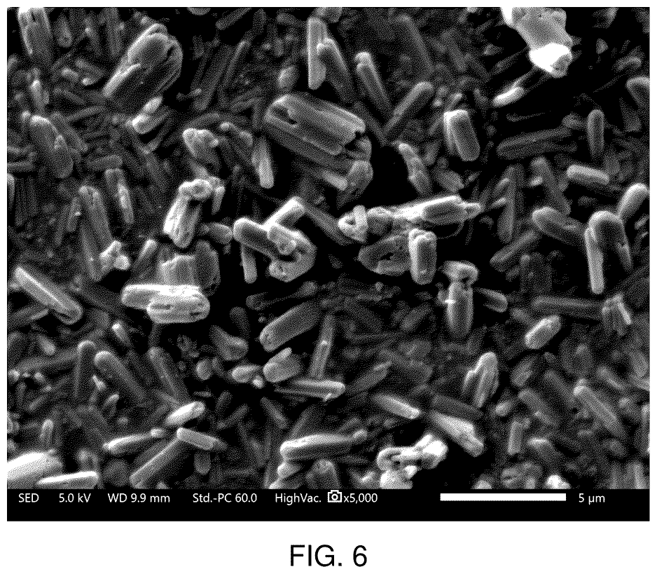

FIGS. 2 to 5 are actual plan projection images by SEM, illustrating the β-type silicon nitride powder of some embodiments of the present disclosure. As illustrated in FIGS. 2 to 5, the primary particles of the β-type silicon nitride powder form a hexagonal column in which the c-axis direction is relatively short with respect to the ab in-plane direction. While the β-type silicon nitride powder manufactured by a conventional manufacture method, as illustrated in FIG. 6, has a needle-like hexagonal column shape relatively long in the c-axis direction, the β-type silicon nitride powder has a hexagonal flat plate shape. That is, in the β-type silicon nitride powder of some embodiments of the present disclosure, it can also be observed from the SEM images that the particle diameter in the ab in-plane direction of the particle shape is significantly larger than the particle diameter in the c-axis direction. In addition, since the β-type silicon nitride powder of some embodiments of the present disclosure is produced without undergoing a pulverization step after synthesis, it can also be observed that separation of each particle is good and that generation of aggregates is significantly suppressed.

The β-type silicon nitride powder of the present embodiment preferably has a thermal conductivity of 0.1 W/mK or more. The β-type silicon nitride powder can have a thermal conductivity equal to or higher than that of a β-type silicon nitride powder produced by adding a conventional Mg compound or Ca compound. The thermal conductivity of the β-type silicon nitride powder can be more preferably 0.12 to 0.13 W/mK or more.

The β-type silicon nitride powder of the present embodiment is characterized by containing a Sr element. The β-type silicon nitride powder of the present embodiment uses an appropriate amount of a Sr compound as an additive, instead of the conventional Mg compound or Ca compound in a manufacturing process. Therefore, the β-type silicon nitride powder contains a predetermined amount (or a detectable amount) of a Sr element. The β-type silicon nitride powder of the present embodiment preferably contains 7.0 wt. % or less of Sr. More preferably, a content of Sr is 0.05 to 7.0 wt. %.

That is, the β-type silicon nitride powder of the present embodiment is an assembly of particles having a particle diameter in the ab in-plane direction larger than that in the c-axis direction (statistically). In addition, the β-type silicon nitride powder of the present embodiment has a thermal conductivity equal to or higher than that of a conventional β-type silicon nitride powder, and thus can have performance equal to or higher than that of a conventional heat dissipation filler. Therefore, in a composite product (resin composition) of a silicon nitride filler and a resin, obtained by embedding a β-type silicon nitride powder in a resin, an amount of the β-type silicon nitride powder of the present embodiment to be added is appropriately adjusted, thereby making it possible to effectively control the anisotropy of the thermal conductivity in the thickness direction and to design a product having various characteristics.

In addition, the β-type silicon nitride powder of the present embodiment is dispersed by being filled and kneaded in a thermoplastic resin or a thermosetting resin to provide a resin composition having heat dissipation performance. For example, a resin composition can be obtained by dispersing by being filled and kneaded a maximum filling amount of a silicon nitride powder in a molten resin, and then curing the molten resin. Here, the resin composition can be selected, without particular limitation, from the group consisting of, for example, thermoplastic resins such as polyethylene and polycarbonate, thermosetting resins such as phenol resins and epoxy resins, silicone resins, rubbers, and the like. Similarly, the β-type silicon nitride powder of the present embodiment is dispersed by being filled and kneaded in a fluid such as grease, an adhesive, or a paint to provide a thermally conductive paste having excellent heat dissipation. Only the β-type silicon nitride powder of the present embodiment may be included in the resin composition or the thermally conductive paste. Alternatively, the β-type silicon nitride powder of the present embodiment and a conventional β-type silicon nitride powder may be included in predetermined proportions (that is, in a relationship between the main filler and the sub filler) in the resin composition or the thermally conductive paste.

Subsequently, a method for manufacturing the β-type silicon nitride powder of the present embodiment will be described. The manufacturing method of the present embodiment includes: (1) a step of producing a mixed powder containing: a raw material containing a predetermined amount of a SiO₂ powder and a predetermined amount of a Sr compound powder; and a predetermined amount of a carbon powder; (2) a step of nitriding the mixed powder by a reductive nitridation reaction in a nitrogen atmosphere; and (3) a step of removing the carbon powder from the mixed powder subjected to reductive nitridation treatment.

First, a SiO₂ powder and a Sr compound powder are provided as a raw material. The SiO₂ powder as a base material preferably contains a high-purity fine powder with less metal impurities. The SiO₂ powder may be provided in the form of a sol (colloidal solution) in which particles are dispersed in a solvent. The Sr compound is preferably SrF₂ which is a halogen compound. Then, the raw material is prepared such that an amount of the Sr compound to be added is 5 to 10 mol %, in terms of a molar ratio, relative to 100 mol % of the SiO₂ powder.

An appropriate amount of a carbon powder is provided. The amount of the carbon powder is preferably 2 to 3 times that of the SiO₂ powder in terms of a molar ratio (C/SiO₂). More preferably, the amount of the carbon powder is 2.4 to 2.7 times that of the SiO₂ powder in terms of a molar ratio. As the carbon powder, fine particles mainly composed of carbon such as furnace black or acetylene black can be used. As the carbon, carbon having an average particle diameter of 10 to 50 nm and an ash content of 0.1% or less is preferably used.

Next, the SiO₂ powder, the Sr compound powder, and the carbon powder are wet-mixed by means of a planetary mill to produce a mixed slurry of the powders. When the mixed slurry is produced, a solution in which a predetermined amount of a dispersant is dissolved in a solvent is provided. Preferably, the solution is an aqueous solution obtained by dissolving a small amount of a dispersant in an appropriate amount of pure water. Preferably, the dispersant is a polymeric dispersant selected from the group consisting of polyvinylpyrrolidone, polyvinyl alcohol and hydroxypropyl cellulose. Preferably, the dispersant is added to pure water in an amount of 0.5 to 1 wt. % with respect to the mixture of the raw material and the carbon powder. The wet mixing is carried out by means of a vibrating mill or a planetary mill. The produced mixed slurry is dried in a thermostatic chamber at 120° C., and then passed through a sieve (for example, opening: 100 μm) to produce a mixed powder for synthesis.

Then, the mixed powder is packed into a carbon sheath having predetermined dimensions. The carbon sheath is disposed in a furnace such that an external atmosphere is introduced into the sheath and CO gas generated in the sheath during reductive nitridation is exhausted to the outside.

Subsequently, the carbon sheath filled with the mixed powder is subjected to a reductive nitridation treatment by a pressurized nitrogen atmosphere furnace of a carbon heater. The reductive nitridation reaction is preferably performed in a temperature environment of 1450 to 1600° C. The reductive nitridation reaction is preferably performed in a nitrogen atmosphere at 2 atm (0.2 MPa) or more. A treatment time of the reductive nitridation synthesis is preferably 1 to 10 hours. When a pressure in the furnace during the reductive nitridation treatment is low, SiC is likely to be generated during the reductive nitridation reaction, and thus the nitrogen pressure is preferably 2 atm or more. In addition, if a treatment temperature of the reductive nitridation is low or the time is short, unreacted SiO₂ may remain. On the other hand, when the temperature of the reductive nitridation is high, grain growth of the silicon nitride particles after the reductive nitridation excessively proceeds, and the columnar shape of the particles becomes remarkable. Therefore, it is necessary to appropriately adjust the treatment temperature and treatment time of the reductive nitridation.

The powder after the reductive nitridation treatment contains an excessive carbon powder, and thus is heated at a temperature of 600° C. to 700° C. in dry air to remove residual carbon. Since a heating time varies under conditions such as a heating temperature, a gas flow rate, and a powder amount, it is preferable to appropriately adjust the heating time while confirming weight reduction. If the heating time is too long, an amount of oxygen in the silicon nitride powder increases, and therefore the heating time is preferably about 2 to 12 hours.

The β-type silicon nitride powder of the present embodiment can be obtained through the above steps. The obtained β-type silicon nitride powder can be confirmed by crystal phase analysis by powder X-ray diffraction and SEM image analysis.

Here, the action of an additive in the reductive nitridation will be described. In a reductive nitridation method of silicon nitride powder, it is necessary to mix at least three types of powders, i.e., a carbon powder, a silicon dioxide powder, and an additive powder. Conventionally, a magnesium compound (MgF₂, MgCO₃, or the like) or a calcium compound (CaF₂, CaCO₃, or the like) has been generally selected as an additive, but some embodiments of the present disclosure are characterized in that a strontium compound (SrF₂) is selected as an additive. Generally, the additive forms a liquid phase during synthesis of a silicon nitride (Si₃N₄) powder, and has an effect of promoting phase transition from α-Si₃N₄ to β-Si₃N₄. The generated liquid phase exists between the particles of silicon nitride, and thus causes fusion of the powders after synthesis, but the additive having a high vapor pressure gradually decreases during synthesis and is removed from between the particles after synthesis. Among alkaline earth additives, Mg and Ca have an effect of extending β-Si₃N₄ crystals in the c-axis direction, whereas Sr has a weak effect thereof, and thus β-Si₃N₄ crystals having a larger diameter in the ab plane are obtained. Although detailed mechanism of such particle growth has not been clarified, it is presumed that Sr having a low ionic electric field intensity, among alkaline earth elements, is caused by weak adsorption of β-Si₃N₄ to the prism plane. Similarly, Ba also has a low ionic electric field intensity, but has a higher vapor pressure than that of Sr, and thus volatilization of the additive proceeds during synthesis. Therefore, Ba is considered to have no effect of causing grain growth in the ab in-plane direction of the crystals.

In the manufacturing method of some embodiments of the present disclosure, the amount of the Sr compound to be added as an additive is controlled to an appropriate amount, thereby causing grain growth in the ab in-plane direction of the crystals, and, as a result, it is possible to obtain a β-type silicon nitride powder containing crystal particles having a particle diameter in the ab in-plane direction larger than that in the c-axis direction.

In addition, the method for manufacturing a β-type silicon nitride powder of some embodiments of the present disclosure is characterized by not including a pulverization treatment of an agglomerate of silicon nitride after a nitridation treatment as in a conventional method. For example, in a conventional method for manufacturing a silicon nitride powder as disclosed in JP 2015-81205 A, an agglomerate of silicon nitride is generated after a nitridation treatment, and subjected to a pulverization treatment to manufacture a silicon nitride powder. Such a pulverization treatment of the agglomerate increases coarse aggregates and particles having a distorted shape in the silicon nitride powder, and, as a result, fluidity of the silicon nitride powder is significantly reduced. Due to this reduction in fluidity of the silicon nitride powder, a viscosity of the fluid mixed with the silicon nitride powder increases, and an amount of the filler to be filled in the fluid and kneadability are limited. Such limitations on fillability and/or kneadability hinder the improvement of heat dissipation performance of a resin composition in which the silicon nitride powder is kneaded. In the manufacturing method of some embodiments of the present disclosure, by examining additives, a fine powder having a uniform particle size can be directly synthesized without undergoing a pulverization step after synthesis.

### EXAMPLES

Hereinafter, embodiments of the present disclosure will be described more specifically with reference to Examples and Comparative Examples, but is not to be construed as being limited by the following Examples.

Beta (β)-type silicon nitride powders according to Examples 1 to 4 and Comparative Examples 1 to 3 were produced under the following conditions and by the following procedures.

Pure water in which 0 to 1.0 wt. % of PVP (Polyvinylpyrrolidone K30, manufactured by FUJIFILM Wako Pure Chemical Corporation) relative to the mixed powder was dissolved was weighed and put into a resin container, and a SiO₂ powder, an appropriate amount of an additive (a Sr compound, a Mg compound, a Ca compound, or a Ba compound) powder, and a carbon powder in an amount about 2.4 to 2.7 times that of SiO₂ in terms of a molar ratio were charged into the resin container. As the SiO₂ powder, a high-purity powder having an average particle diameter of 0.4 μm was used. A sol obtained by dispersing a SiO₂ powder (for example, having an average particle diameter of 0.04 μm) in a solvent may be used. Then, raw materials were wet-mixed using the resin container and silicon nitride balls. The wet mixing was performed by a vibration mill or a planetary mill to produce a mixed slurry. The mixed slurry was dried in a thermostatic chamber at 120° C., and then passed through a sieve (opening: 100 μm) to produce a mixed powder for synthesis. The mixed powder was filled in a carbon sheath and charged into a furnace. The carbon sheath was disposed in the furnace so as to provide a gap of about 10 mm between a frame and a lid, and an external atmosphere was disposed inside the sheath. After the inside of the furnace was evacuated before heating, the nitrogen pressure in the furnace was increased to 0.8 MPa, and reductive nitridation was performed at 1500° C. or 1600° C. for about 10 hours. Then, silicon nitride powders of Examples 1 to 4 and Comparative Examples 1 to 3 were produced by heating in dry air at a temperature of 700° C. for 3 hours until the weight of carbon reached 0 to remove residual carbon.

Powder X-ray diffraction measurement was performed on each of the produced samples of Examples 1 to 4 and Comparative Examples 1 to 3. By referring to the peak position of its X-ray diffraction pattern, it was confirmed that a silicon nitride powder had been produced. By analyzing the X-ray diffraction pattern, the β fraction indicating the mass fraction of β-type silicon nitride in the synthesized powder was derived. In each sample, the silicon nitride powder showed a β fraction of 98.1 to 100%, and β-type silicon nitride (β-Si₃N₄) particles having a high thermal conductivity were confirmed to have been formed in a proportion of 80% or more. In addition, an SEM photograph (at a magnification of 5000 times, and at a magnification of 40000 times only for Comparative Example 3) was acquired in order to analyze the particle shape and particle cross-sectional shape of the silicon nitride powder. The obtained SEM photograph was subjected to image analysis with a computer to evaluate the shape characteristics of primary particles.

Various measurements and analyses were performed under the following conditions.

### (1) Powder X-Ray Diffraction Measurement

The synthesized powder after decarburization was passed through a sieve having an opening of 30 μm to remove an aggregated powder, thereby obtaining a powder for measurement. The powder after sieving was filled in an aluminum sample holder having a depth of 2 mm, and compressed with a slide glass to smooth a sample surface. At this time, the sample surface was uniformly filled so that the sample surface coincided with a reference surface, and the sample surface was slid to be stroked using an edge of the slide glass. With this sample surface as a measurement target, the X-ray diffraction intensity of each sample was measured by a powder X-ray diffraction method using Cu-Kα rays using a powder X-ray diffractometer UltimaIV manufactured by Rigaku Corporation.

### (2) Calculation of β Fraction

Based on the X-ray diffraction pattern obtained by the powder X-ray diffraction measurement, the integrated intensity of the diffraction pattern of each of a Si phase, an α-type silicon nitride phase, and a β-type silicon nitride phase was used to measure the mass fraction of the crystal phase by the known method of Jovanovic and Kimura represented by the following three formulas.

$$\frac{{I}_{α} ( 102 ) + {I}_{α} ( 210 )}{{I}_{β} ( 101 ) + {I}_{β} ( 120 )} = 0.647 \frac{{W}_{α}}{{W}_{β}} \qquad [ Mathematical formula 1 ]$$

$$\frac{{I}_{Si} ( 111 )}{{I}_{α} ( 201 )} = 0.647 \frac{{W}_{Si}}{{W}_{α}}$$

$${W}_{α} + {W}_{β} + {W}_{Si} = 1$$

### (3) Calculation of Iβ (101)/Iβ (210)

From the X-ray diffraction pattern obtained by the powder X-ray diffraction measurement, the diffraction peak intensity Iβ (210) of the (210) plane of β-Si₃N₄ and the diffraction peak intensity Iβ (101) of the (101) plane thereof were measured as integrated intensities by analysis software, and the peak intensity ratio Iβ (101)/Iβ (210) was calculated.

### (4) Shape Observation and Analysis of Powder by SEM

The shape of the powder was observed using a scanning electron microscope JSM-IT700HR manufactured by JEOL Ltd. A sample of silicon nitride powder was dispersed over a carbon tape using a dry powder disperser (PD-10 manufactured by AmbiValue), and Pt was sputtered on the surface of the powder as an electro-conductive coating film to obtain an observation sample. An acceleration voltage was set to 5 kV, and an SE (Secondary Electron) image was acquired at an observation magnification of 5000 times (or 40000 times). The acquired SE image was imported into WinROOF2021 (Ver 5.7.4) manufactured by MITANI CORPORATION, and image analysis was performed by a computer. Specifically, a filter operation, noise removal, binarization processing, and the like were performed on the imported image to process the shape characteristics of the primary particles, and the length (particle diameter) W in the ab in-plane direction and the length (particle diameter) L in the c-axis direction of the primary particles were measured. For 50 or more primary particles in which both the length W in the ab in-plane direction and the length L in the c-axis direction could be discriminated, W and L were measured (see FIG. 9), and average values thereof were calculated. The average aspect ratio W/L was determined from the calculated average values.

### (5) Measurement of Thermal Conductivity

The thermal conductivity of a paste was measured using a thermal conductivity measuring apparatus (TRIDENT, C-Therm Technologies Ltd.). In particular, 1.8 cc of the synthesized powder after passing through a sieve having an opening of 30 μm was set in a planar heat source sensor (Modified Transient Plane Source), measurement was performed 5 times per sample in a state where a load of 2 kgf was applied, and an average value thereof was taken as a measured value. The thermal conductivity was measured at room temperature (25° C.).

### (6) Sr Content

The Sr content of the β-type silicon nitride powder synthesized in the examples was measured using a Primus IV scanning X-ray fluorescence analyzer manufactured by Rigaku Corporation. Measurement samples were prepared by adding 4 wt % binder to the powder after decarburization and molding it into pellets with dimensions of Φ20 mm×2 mm-t. The molded pellets were placed in a Φ10 mm sample mask, and elemental analysis was performed using standardless FP analysis. The analytical values for Si and Sr were reported on a metal basis (wt %).

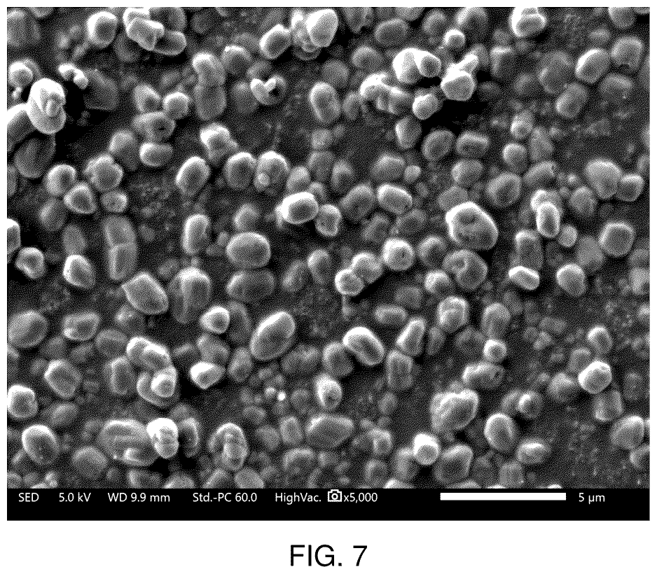

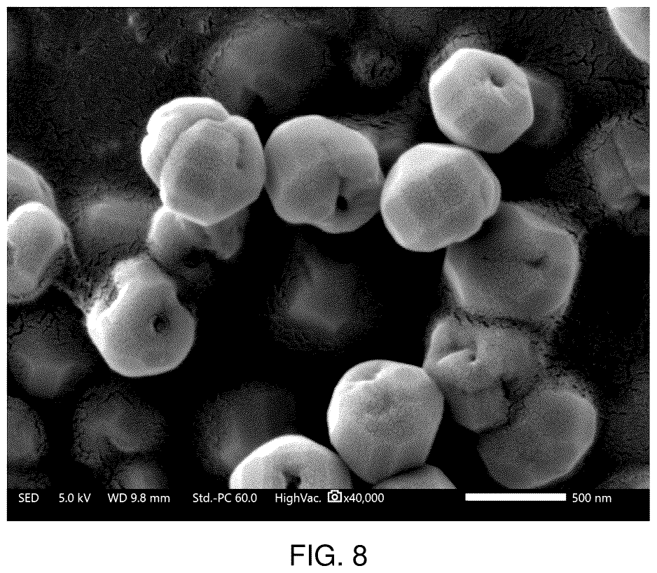

The conditions and various measurement results for each of the samples of Examples 1 to 4 and Comparative Examples 1 to 3 are shown in Table 2. FIG. 1 illustrates X-ray diffraction patterns of the samples of Examples 1 to 4 and Comparative Examples 1 to 3. FIGS. 2 to 5 illustrate SE images of Examples 1 to 4 at an observation magnification of 5000 times. FIGS. 6 to 8 illustrate SE images of Comparative Examples 1 to 3 at an observation magnification of 5000 times (40000 times only for Comparative Example 3).

TABLE 2

| | | | | Reductive | | | | | | | |
|---|---|---|---|---|---|---|---|---|---|---|---|
| | | | | nitridation | | | | | | | |
| | | | | treatment | | | | | | | |
| | Blending ratio between raw | | | condition | Characteristics | | | | | | |
| | materials | | | Treatment | | | Iβ | | | | Thermal |
| | SiO₂ | Additive | | temperature | Iβ (101) | Iβ (210) | (101)/ | W | | | conductivity |
| | (mol %) | (mol %) | Type | (° C.) | (cps) | (cps) | Iβ (210) | (μm) | L (μm) | W/L | (W/mK) |
| Example 1 | 100 | 7 | SrF₂ | 1600 | 97917 | 79750 | 1.23 | 1.88 | 0.60 | 3.27 | 0.124 |
| Example 2 | 100 | 5 | SrF₂ | 1600 | 84500 | 76450 | 1.11 | 2.75 | 0.90 | 3.75 | 0.126 |
| Example 3 | 100 | 10 | SrF₂ | 1600 | 106000 | 69183 | 1.53 | 2.96 | 0.85 | 3.69 | 0.129 |
| Example 4 | 100 | 7 | SrF₂ | 1500 | 137350 | 97667 | 1.41 | 2.94 | 1.11 | 2.66 | 0.129 |
| Comparative | 100 | 7 | MgF₂ | 1600 | 59983 | 71683 | 0.84 | 1.02 | 2.37 | 0.43 | 0.110 |
| Example 1 | | | | | | | | | | | |
| Comparative | 100 | 7 | CaF₂ | 1600 | 74550 | 85117 | 0.88 | 1.11 | 1.28 | 0.87 | 0.098 |
| Example 2 | | | | | | | | | | | |
| Comparative | 100 | 7 | BaF₂ | 1600 | 71117 | 67633 | 1.05 | 0.60 | 0.54 | 1.11 | 0.084 |
| Example 3 | | | | | | | | | | | |

Examples 1 to 4 are samples produced from a mixed powder composed of a SiO₂ powder, a Sr compound (SrF₂), and a carbon powder. The Sr contents in the β-type silicon nitride powders of Examples 1 to 4 were as follows: 1.7 wt % (Si: 98.3 wt %) for Example 1; 0.3 wt % (Si: 99.7 wt %) for Example 2; 4.2 wt % (Si: 95.8 wt %) for Example 3; and 5.8 wt % (Si: 94.2 wt %) for Example 4. Comparative Example 1 is a sample produced from a mixed powder composed of a SiO₂ powder, a Mg compound (MgF₂), and a carbon powder. Comparative Example 2 is a sample produced from a mixed powder composed of a SiO₂ powder, a Ca compound (CaF₂), and a carbon powder. Comparative Example 3 is a sample produced from a mixed powder composed of a SiO₂ powder, a Ba compound (BaF₂), and a carbon powder.

According to the SEM photographs of FIGS. 1 to 4, it was observed that the separation of each particle was good and that the generation of aggregates was significantly suppressed, in the acquired SE images of Examples 1 to 4. In addition, it was observed that Examples 1 to 4 had a flat hexagonal plate shape in which the c-axis direction was relatively shorter than the ab in-plane direction, whereas Comparative Examples 1 and 2 using the conventional additives (Mg compound and Ca compound, respectively) had a hexagonal columnar shape in which at least the c-axis direction was relatively longer than the ab in-plane direction. On the other hand, Comparative Example 3 in which the Ba compound was used as the additive has a smaller size, a smaller aspect ratio, and a particle shape closer to a spherical shape.

Table 2 quantitatively shows the characteristics of each sample.

According to Table 2, in Examples 1 to 4, the Iβ (101)/Iβ (210) is 1.11 to 1.53. On the other hand, in Comparative Example 1 in which a Mg compound was used as the additive, the Iβ (101)/Iβ (210) is 0.84, and it can be seen that particles having a particle diameter in the ab in-plane direction smaller than that in the c-axis direction are statistically superior. In Comparative Example 2 in which a Ca compound was used as the additive, the Iβ (101)/Iβ (210) is 0.88, and it can be seen that particles having a particle diameter in the ab in-plane direction smaller than that in the c-axis direction are statistically superior, as in Comparative Example 1. In Comparative Example 3 in which a Ba compound was used as the additive, the Iβ (101)/Iβ (210) is 1.05, which can be said to be close to random orientation (Iβ (101)/Iβ (210)=1). That is, in Examples 1 to 4, the Iβ (101)/Iβ (210) is larger than 1 (random orientation) and significantly larger than those of Comparative Examples 1 to 3. This result quantitatively shows that in the β-type silicon nitride powder of some embodiments of the present disclosure, particles having a particle diameter in the ab in-plane direction larger than that in the c-axis direction are statistically dominant, similarly to the observation results by the SEM photographs.

In Examples 1 to 4, the average length W of the primary particles in the ab in-plane direction is 1.88 to 2.96 μm, the average length L thereof in the c-axis direction is 0.60 to 1.11 μm, and the W/L is 2.6 to 3.8 (>1). On the other hand, in Comparative Example 1 in which a Mg compound was used as the additive, the average length W of the primary particles in the ab in-plane direction is 1.02 μm, the average length L thereof in the c-axis direction is 2.37 μm, and the W/L is 0.4 (<1). In Comparative Example 2 in which a Ca compound was used as the additive, the average length W of the primary particles in the ab in-plane direction is 1.11 μm, the average length L thereof in the c-axis direction is 1.28 μm, and the W/L is 0.9 (<1). In Comparative Example 3 in which a Ba compound was used as the additive, the average length W of the primary particles in the ab in-plane direction is 0.60 μm, the average length L thereof in the c-axis direction is 0.54 μm, and the W/L is 1.1 (>1). This result quantitatively shows that in the β-type silicon nitride powder of some embodiments of the present disclosure, primary particles have a particle shape in which the particle diameter in the ab in-plane direction is larger than that in the c-axis direction, similarly to the observation results by the SEM photographs.

Furthermore, in Examples 1 to 4, the thermal conductivity is 0.124 to 0.129 W/mK. On the other hand, in Comparative Example 1 in which a Mg compound was used as the additive, the thermal conductivity is 0.110 W/mK. In Comparative Example 2 in which a Ca compound was used as the additive, the thermal conductivity is 0.098 W/mK. In Comparative Example 3 in which a Ba compound was used as the additive, the thermal conductivity is 0.084 W/mK. That is, the thermal conductivities of Examples 1 to 4 are significantly higher than the thermal conductivities of Comparative Examples 1 to 3. This result shows that the β-type silicon nitride powder of some embodiments of the present disclosure is improved also in thermal conductivity as compared with conventional ones.

Therefore, in the present disclosure, it was demonstrated that a β-type silicon nitride powder containing crystal particles having a particle diameter in the ab in-plane direction larger than that in the c-axis direction while having a thermal conductivity equal to or higher than that of a conventional β-type silicon nitride powder was obtained.

The scope of protection is not limited to the above-described Examples, and can be implemented in various modes as long as they belong to the technical scope of the present disclosure.

What is claimed is:

1. A β-type silicon nitride powder having a β fraction of 80% or more, wherein
Iβ (101)/Iβ (210), which is a ratio between an X-ray diffraction peak intensity Iβ (101) of a (101) plane of β-Si₃N₄ and an X-ray diffraction peak intensity Iβ (210) of a (210) plane of β-Si₃N₄, is 1.1 or more, the X-ray diffraction peak intensities being obtained from an X-ray diffraction pattern of the β-type silicon nitride powder.

2. The β-type silicon nitride powder according to claim 1, wherein an average aspect ratio W/L is 2.5 or more, where L is a length of primary particles in a c-axis direction, and W is a length of the primary particles in an ab in-plane direction.

3. The β-type silicon nitride powder according to claim 1, wherein a thermal conductivity is 0.12 W/mK or more.

4. The β-type silicon nitride powder according to claim 1, wherein the β-type silicon nitride powder comprises a Sr element.

5. A resin composition comprising the β-type silicon nitride powder according to claim 1.

6. The resin composition according to claim 5, wherein the resin composition is a thermoplastic resin or a thermosetting resin.

7. A thermally conductive paste comprising the β-type silicon nitride powder according to claim 1.

8. A β-type silicon nitride powder having a β fraction of 80% or more, wherein
an average aspect ratio W/L is 2.5 or more, where L is a length of primary particles in a c-axis direction, and W is a length of the primary particles in an ab in-plane direction.

9. A method for manufacturing a β-type silicon nitride powder having a β fraction of 80% or more, the method comprising:
producing a mixed powder comprising: a raw material comprising a predetermined amount of a SiO₂ powder and a predetermined amount of a Sr compound powder; and a predetermined amount of a carbon powder; and
nitriding the mixed powder by a reductive nitridation reaction in a nitrogen atmosphere.

10. The method according to claim 9, wherein the Sr compound powder is a halogen compound powder.

11. The method according to claim 9, wherein an amount of the Sr compound to be added is 5 to 10 mol % relative to 100 mol % of the SiO₂ powder.
